(19) United States
(12) Patent Application Publication
(10) Pub. No.: US 2016/0311376 A1
(43) Pub. Date: Oct. 27, 2016

(54) MOBILE TANK FOR STORING A LIQUID

(71) Applicant: BAKERCORP INTERNATIONAL B.V., Zevenbergschen Hoek (NL)

(72) Inventors: Matthijs Alexander Johannes Dokter, Wilp (NL); Evert Stobbelaar, Lemelerveld (NL)

(21) Appl. No.: 15/102,133

(22) PCT Filed: Dec. 5, 2014
(86) PCT No.: PCT/NL2014/050833

§ 371 Date: Jun. 6, 2016

(30) Foreign Application Priority Data
Dec. 6, 2013 (NL) 2011908

(51) Int. Cl. B60R 3/00; B60P 3/22; B65D 90/14; B65D 88/12; B65D 90/22

(52) U.S. Cl. CPC B60R 3/005; B65D 88/12; B65D 90/22; B65D 90/14; B60P 3/224

(57) ABSTRACT

A mobile tank for storing a liquid includes a bottom part, a top part and side walls extending from the bottom part to the top part to form a liquid reservoir. A safety rail is pivotably connected to an upper surface of the top part, which safety rail is pivotable from a laid down position into a raised position, and vice versa. The safety rail includes two, and only two, support legs positioned at a first distance from each other and extending in a flat plane. The safety rail further includes a rail part connected to upper ends of the support legs, which rail part extends in the plane and in a direction transverse to the support legs over a second distance being larger than the first distance of the support legs, the safety rail includes one, and only one, connector by which the safety rail is connected to the upper surface, and each of the support legs is at a lower end thereof pivotable coupled to the connector.

### CROSS-REFERENCE TO RELATED APPLICATIONS

This application is the National Stage of International Application No. PCT/NL2014/050833 filed Dec. 5, 2014, which claims the benefit of Netherlands Application No. NL 2011908, filed Dec. 6, 2013, the contents of which is incorporated by reference herein.

### FIELD OF THE INVENTION

The invention relates to mobile tanks for storing a liquid. The mobile tanks have typically a bottom part, a top part and side walls extending from the bottom part to the top part to form a liquid reservoir. In use, liquid is stored in the liquid reservoir. In practice, these tanks are often used to temporarily store a liquid, until it is transported to a different location. Long term storage of liquid is also possible.

The top part has an upper surface. Persons need to be able to perform operations on the upper surface in a safe manner. To ensure this, safety rails are provided on the upper surface to prevent that a person falls from the upper surface. In this situation, the safety rail extends from the upper surface.

Since the mobile tanks are in general often transported, it is required that the safety rail can be placed in a lowered configuration.

### BACKGROUND OF THE INVENTION

The invention is based on the insight that the known mobile tanks are difficult to build. The invention is furthermore based on the insight that the known safety rails are not user friendly.

### SUMMARY OF THE INVENTION

The invention has the objective to provide an improved or alternative mobile tank. The mobile tank according to the present invention comprises a bottom part, a top part and side walls extending from the bottom part to the top part to form a liquid reservoir, wherein;

a safety rail is pivotable connected to an upper surface of the top part, which safety rail is pivotable from a laid down position into a raised position, and vice versa,
the safety rail comprises two, and only two, support legs positioned at a first distance from each other and extending in a flat plane,
the safety rail further comprises a rail part connected to upper ends of the support legs, which rail part extends in the plane and in a direction transverse to the support legs over a second distance being larger than the first distance of the support legs,
the safety rail comprises one, and only one, connector by which the safety rail is connected to the upper surface, and
each of the support legs is at a lower end thereof pivotable coupled to the connector.

This allows that during the building of the mobile tank, only one connector has to be connected to the upper surface to mount the safety rail. This operation can be performed by a single person in an easier manner, when compared to safety rails which are connected by multiple connectors. Due to this, the mobile tank can be built in a more efficient manner. A mobile tank has often multiple safety rails connected to the upper surface. Which means that this can lead to a relatively large reduction in the production time and labour costs of the mobile tank. In addition to this, the mobile tank has a simpler construction.

In an embodiment of the mobile tank according to the invention, the safety rail has a T-like form.

In an embodiment of the mobile tank according to the invention, the two support legs are pivotable about one, and only one, pivot axis.

In an embodiment of the mobile tank according to the invention, the two support legs are coupled to the connector via one, and only one, pivot axle.

In an embodiment of the mobile tank according to the invention, the second distance of the rail part is between 5-15 times, preferably 10 times, larger than the first distance of the support legs.

In an embodiment of the mobile tank according to the invention, the first distance of the support legs is between 1 and 20 cm.

In an embodiment of the mobile tank according to the invention, the two support legs are formed by a first tube and a parallel extending second tube, the rail part comprises a lower rail section, an intermediate rail section and an upper rail section, the lower rail section is formed by a third tube connected at the upper end of the first tube and extending perpendicular to the first tube and a fourth tube connected at the upper end of the second tube and extending perpendicular to the second tube, which third and fourth tube extend in opposite directions, the intermediate rail section is formed by a fifth tube connected to the third tube and extending perpendicular to the third tube and away from the first tube and by a sixth tube connected to the fourth tube and extending perpendicular to the fourth tube and away from the second tube, and the upper rail section is formed by a seventh tube connected to the fifth and sixth tube and extending perpendicular to the fifth and sixth tube.

In an embodiment of the mobile tank according to the invention, the first, second, third, fourth, fifth, sixth, and seventh tube all extend in the flat plane.

In an embodiment of the mobile tank according to the invention, the rail part is extendable such that the second distance over which the rail part extends can be increased.

In an embodiment of the mobile tank according to the invention, the third and seventh tube are extendable and/or the fourth and seventh tube are extendable.

In an embodiment of the mobile tank according to the invention, the safety rail is formed by a single tubular element which is bend to form the first, second, third, fourth, fifth, sixth, and seventh tube.

In an embodiment of the mobile tank according to the invention, the safety rail extends in the laid down position under a first angle smaller than 10° relative to the upper surface and in the raised position at a second angle between 80°-100° relative to the upper surface.

In an embodiment of the mobile tank according to the invention, the connector comprises a base plate which is connected to the upper surface and two upright plates and wherein each of the two support legs is pivotable coupled to a different one of the upright plates.

In an embodiment of the mobile tank according to the invention, each support leg comprises a longitudinal leg axis and is movable relative to the upright plate to which it is connected in the direction of its longitudinal leg axis, each support leg further comprises a fixation member, each upright plate comprises an upper fixation slot and a lower fixation slot, the upper fixation slots of the two upright plates are positioned to receive the fixation members of the support legs when the safety rail is in its raised position moved along the longitudinal leg axes and towards the upright plates in order to prevent that the safety rail is pivoted out of the raised position, and the lower fixation slots of the two upright plates are positioned to receive the fixation members of the support legs when the safety rail is in its laid down position moved along the longitudinal leg axes and towards the upright plates in order to prevent that the safety rail is pivoted out of the laid down position.

In an embodiment of the mobile tank according to the invention, the upper fixation slots are formed to allow that gravity working on the safety rail located in the raised position facilitates the movement of the fixation members into the upper fixation slots and the lower fixation slots are formed to allow that gravity working on the safety rail located in the laid down position facilitates the movement of the fixation members into the lower fixation slots.

In an embodiment of the mobile tank according to the invention, the safety rail comprises at least one tension member, such as a spring, the tension member is (directly or indirectly) attached to at least one of the support legs and to a pivot axle by which said support leg is coupled to the connector, and the tension member actively pulls the support legs towards the connector. This tends to facilitate that the fixation members remain in the upper fixation slots or the lower fixation slots, when the safety rail is located in the raised position or the laid down position, respectively.

In an embodiment of the mobile tank according to the invention, each of the support legs comprises at the lower end a plate recess in which one of the upright plates is positioned such that the support leg extends at opposite sides of the respective upright plate. This tends to increase the stability of the safety rail during the pivoting from the laid down position 8 in the raised position, and vice versa.

In an embodiment of the mobile tank according to the invention, multiple safety rails are connected to the upper surface, which safety rails are positioned to surround at least part of the upper surface.

### BRIEF DESCRIPTION OF THE DRAWINGS

Embodiments of the mobile tank will be described by way of example only, with reference to the accompanying schematic drawings in which corresponding reference symbols indicate corresponding parts, and in which:

FIG. 1 schematically shows a view in perspective of an embodiment of the mobile tank according to the invention, which mobile tank comprises a safety rail located in a raised position,

FIG. 2 schematically shows a view in perspective of the mobile tank of FIG. 1, which mobile tank comprises a safety rail located in a laid down position,

FIG. 3 schematically shows an enlarged view in perspective of one of the safety rails of the mobile tank of FIG. 1 in the raised position,

the FIGS. 4 and 5 schematically show enlarged views of the support legs and the connector of the safety rail of FIG. 3,

FIG. 6 schematically shows an enlarged view in perspective of the safety rail of FIG. 3 in the laid down position,

FIG. 7 schematically shows an enlarged view of the support legs and the connector of the safety rail of FIG. 6,

FIG. 8 schematically shows a front view an alternative embodiment of the safety rail for the mobile tank according to the invention,

FIG. 9 schematically shows a side view of the safety rail of FIG. 3 in the raised position,

the FIG. 10-13 schematically show enlarged side views of the support legs and the connector of the safety rail of FIG. 9, which safety rail is moved from the raised position into the laid down position,

FIG. 14 schematically shows a front view of another alternative embodiment of the safety rail for the mobile tank according to the invention,

FIG. 15 schematically shows an enlarged view in perspective of the extendable rail part of the safety rail of FIG. 14,

FIG. 16 schematically shows a front view of the safety rail of FIG. 14,

FIG. 17 schematically shows an enlarged view in perspective of the extendable rail part of the safety rail of FIG. 16,

FIG. 18 schematically shows a front view of another alternative embodiment of the safety rail for the mobile tank according to the invention, and

FIG. 19 schematically shows an enlarged front view of the support legs and the connector of the safety rail of FIG. 18.

### DETAILED DESCRIPTION OF THE DRAWINGS

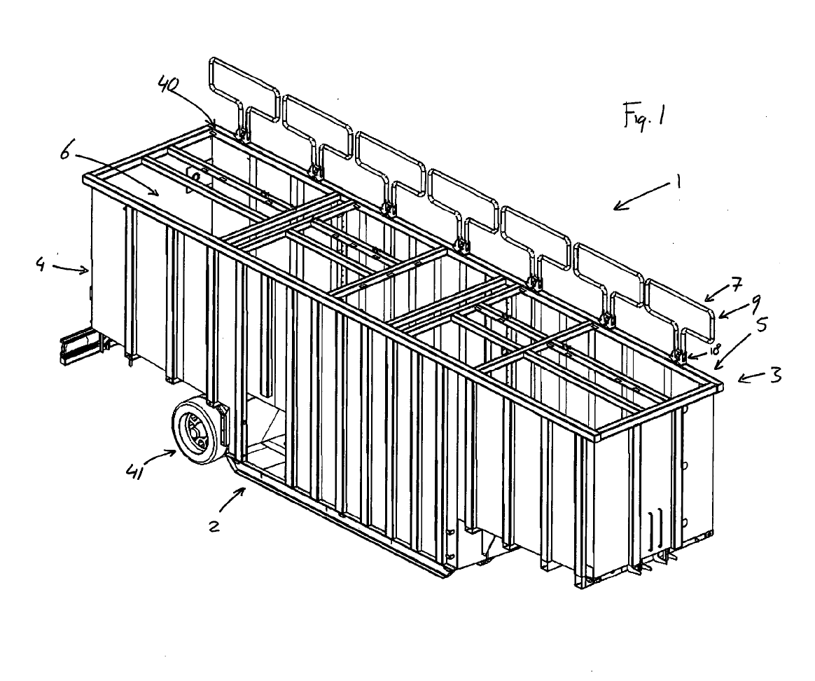

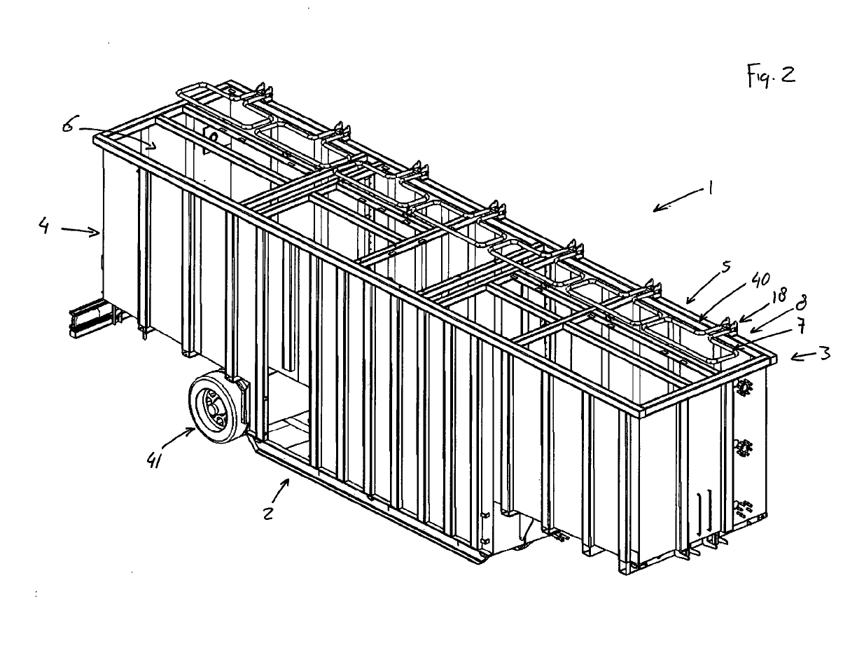

FIG. 1 shows a view in perspective of an embodiment of the mobile tank 1 according to the invention. The mobile tank 1 comprises a bottom part 2, a top part 3 and side walls 4 extending from the bottom part 2 to the top part 3 to form a liquid reservoir 6. In use, a liquid is stored in the liquid reservoir 6. A safety rail 7 is pivotable connected to an upper surface 5 of the top part 3. The safety rail 7 is pivotable from a laid down position 8 into a raised position 9, and vice versa. The safety rail 7 comprises two, and only two, support legs 10 positioned at a first distance D1 from each other and extending in a flat plane 13. The safety rail 7 further comprises a rail part 14 connected to upper ends 11 of the support legs 10, which rail part 14 extends in the plane and in a direction transverse to the support legs 10 over a second distance D2 being larger than the first distance D1 of the support legs 10. The safety rail 7 comprises one, and only one, connector 18 by which the safety rail 7 is connected to the upper surface 5, and each of the support legs 10 is at a lower end 12 thereof pivotable coupled to the connector 18.

This allows that during the building of the mobile tank 1, only one connector 18 has to be connected to the upper surface 5 to mount the safety rail 7. This operation can be performed by a single person in an easier way, when compared to safety rails which are connected by multiple connectors 18. Due to this, the mobile tank 1 can be built in a more efficient manner. A mobile tank 1 has often multiple safety rails 7 connected to the upper surface 5, which means that this can lead to a relatively large reduction in the production time and labour costs of the mobile tank 1. In addition to this, the mobile tank 1 has a simpler construction.

The mobile tank 1 comprises wheels 41 and is constructed to be transported over a road. The mobile tank 1 can be coupled to a vehicle, but other ways of transporting the mobile tank 1 are possible.

The upper surface 5 of the top part 3 comprises four surface edges 40 which define an area where an upper plate is located. The upper plate forms part of the upper surface 5 and is not shown to obtain a view inside the liquid reservoir 6. In FIG. 1, the several safety rails 7 are positioned side by side on one of the surface edges 40. In practice, the other three surface edges 40 are in the same manner provided with safety rails 7. This way, the safety rails 7 surround the upper surface 5. The safety rails 7 are positioned in a raised position 9. This way, the safety rails 7 can function as a safety barrier for a person standing on the upper surface 5.

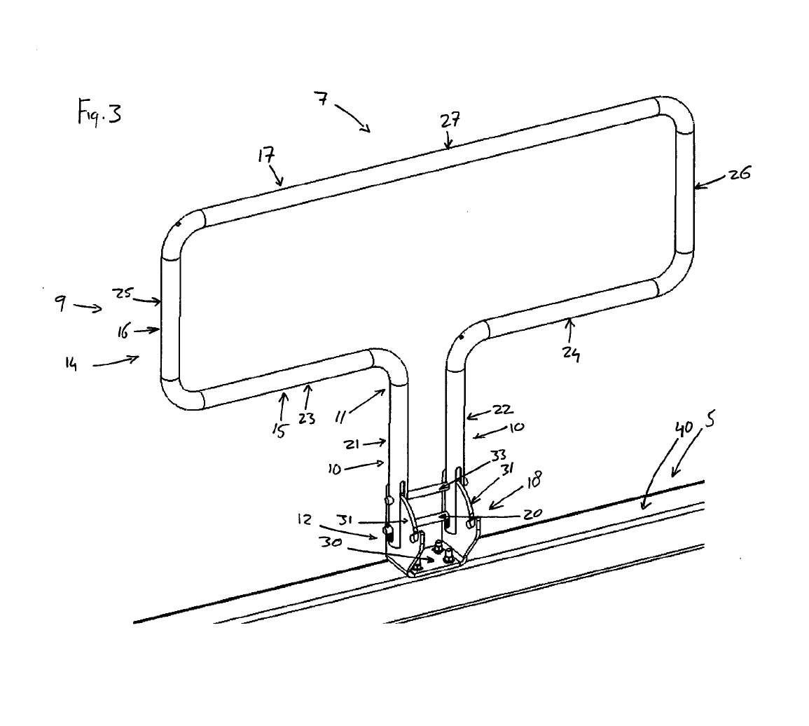

In FIG. 2, the safety rails 7 are positioned in a laid down position 8. This facilitates the transportation of the mobile tank 1.

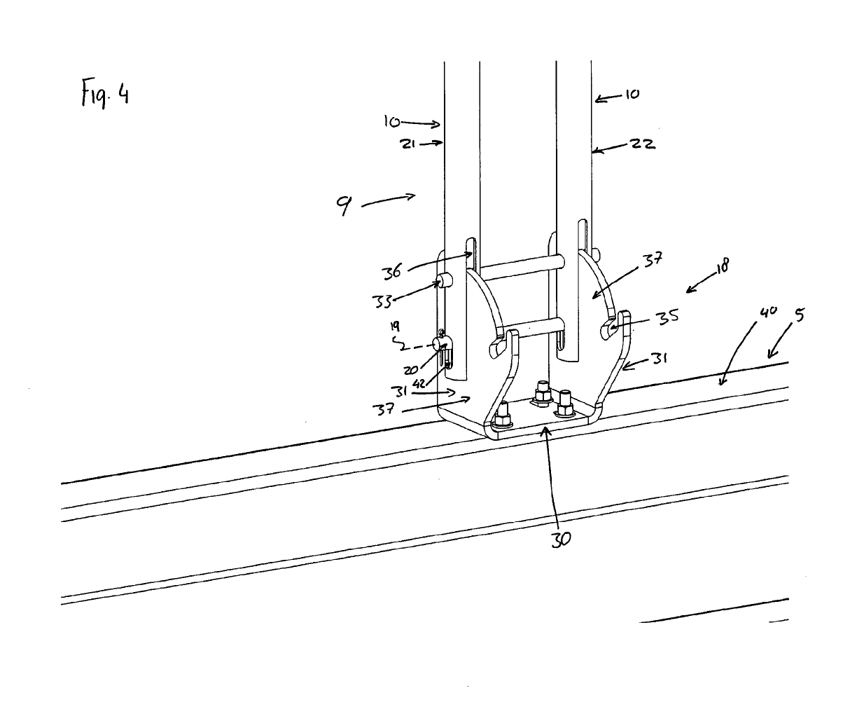

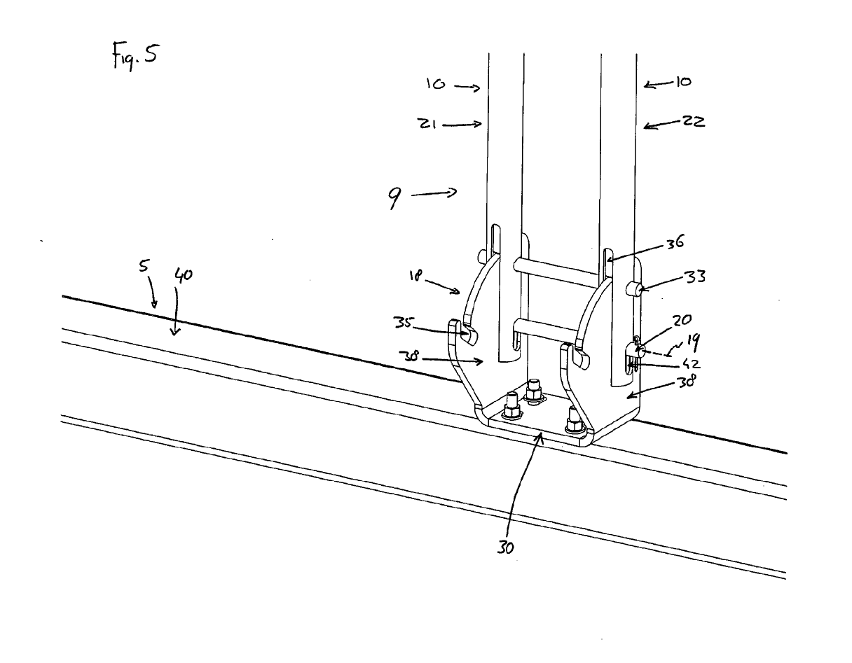

FIG. 3 shows an enlarged view in perspective of one of the safety rails 7 of the mobile tank 1 of FIG. 1. The safety rail 7 has a T-like form. The FIGS. 4 and 5 show enlarged views of the support legs 10 and the connector 18 of the safety rail 7 of FIG. 3.

The safety rail 7 is located in the raised position 9. The safety rail 7 extends perpendicular to the upper surface 5. In other embodiments of the mobile tank 1, the safety rail 7 extends under an angle between 80° and 100° degrees with the upper surface 5.

The two support legs 10 are pivotable about one, and only one, pivot axis 19. The two support legs 10 are coupled to the connector 18 via one, and only one, pivot axle 20.

The connector 18 comprises a base plate 30 which is connected to the upper surface 5 and two upright plates 31. Each of the two support legs 10 is pivotable coupled to a different one of the upright plates 31.

Each of the support legs 10 comprises at the lower end 12 a plate recess 36 in which one of the upright plates 31 is positioned, such that the support leg 10 extends at opposite sides 37, 38 of the respective upright plate 31. This increases the stability of the safety rail 7 during the pivoting from the laid down position 8 in the raised position 9, and vice versa. In other examples, each support leg 10 is completely positioned at one of the sides 37, 38 of the upright plate 31 to which the support leg 10 is connected.

The two support legs 10 are formed by a first tube 21 and a parallel extending second tube 22. The rail part 14 comprises a lower rail section 15, an intermediate rail section 17 and an upper rail section 16. The lower rail section 15 is formed by a third tube 23 connected at the upper end 11 of the first tube 21 and extending perpendicular to the first tube 21 and a fourth tube 24 connected at the upper end 11 of the second tube 22 and extending perpendicular to the second tube 22, which third and fourth tube 24 extend in opposite directions. The intermediate rail section 17 is formed by a fifth tube 25 connected to the third tube 23 and extending perpendicular to the third tube 23 and away from the first tube 21 and by a sixth tube 26 connected to the fourth tube 24 and extending perpendicular to the fourth tube 24 and away from the second tube 22. The upper rail section 16 is formed by a seventh tube 27 connected to the fifth and sixth tube 26 and extending perpendicular to the fifth and sixth tube 26. The first, second, third, fourth, fifth, sixth, and seventh tube 27 all extend in the flat plane 13. In FIG. 3, the first, second, third, fourth, fifth, sixth, and seventh tube 27 are made of separate tube elements which are interconnected.

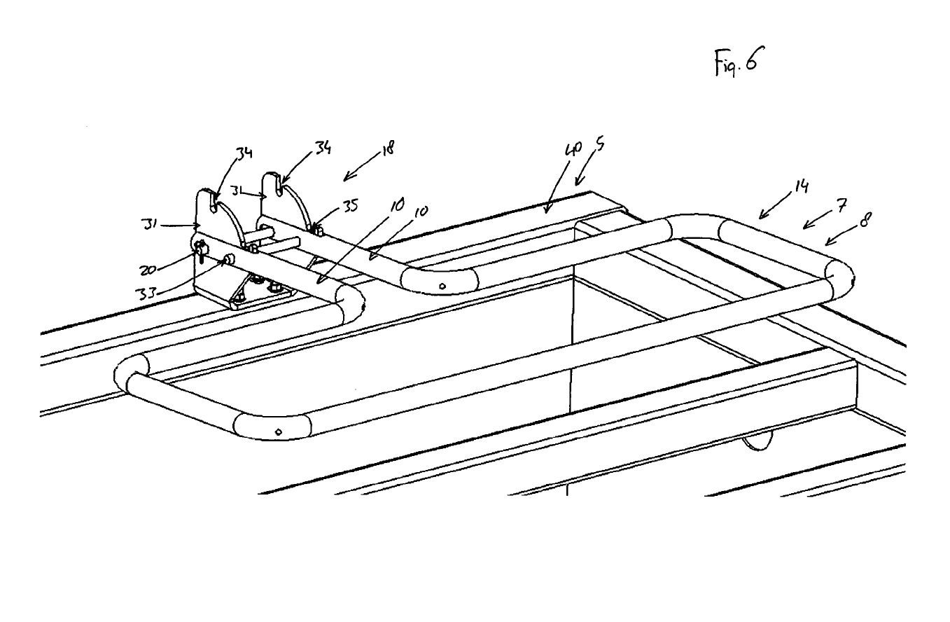

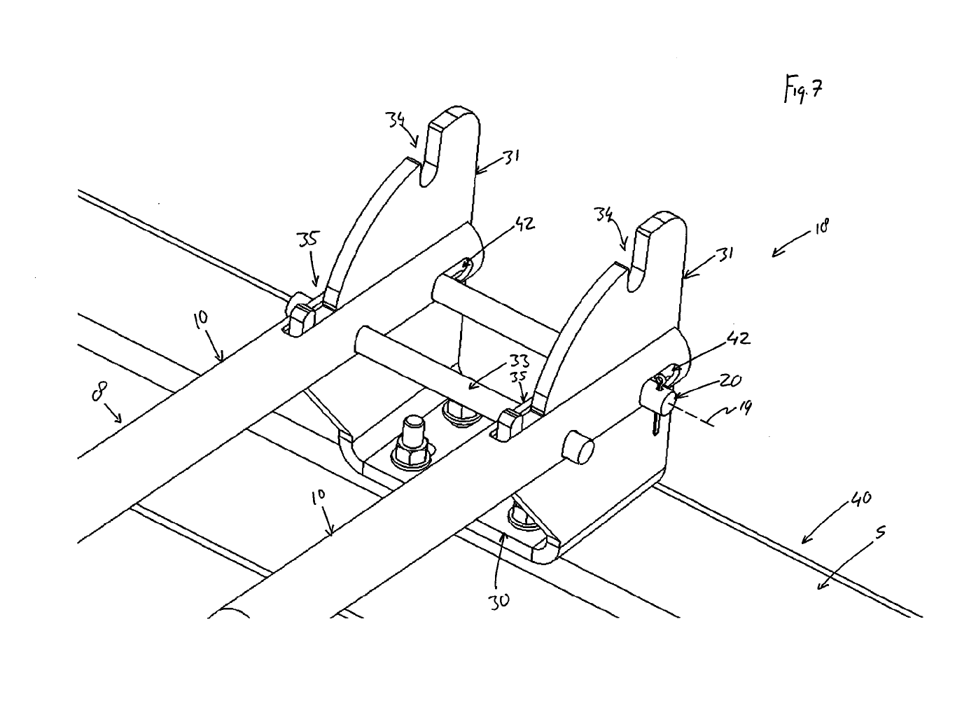

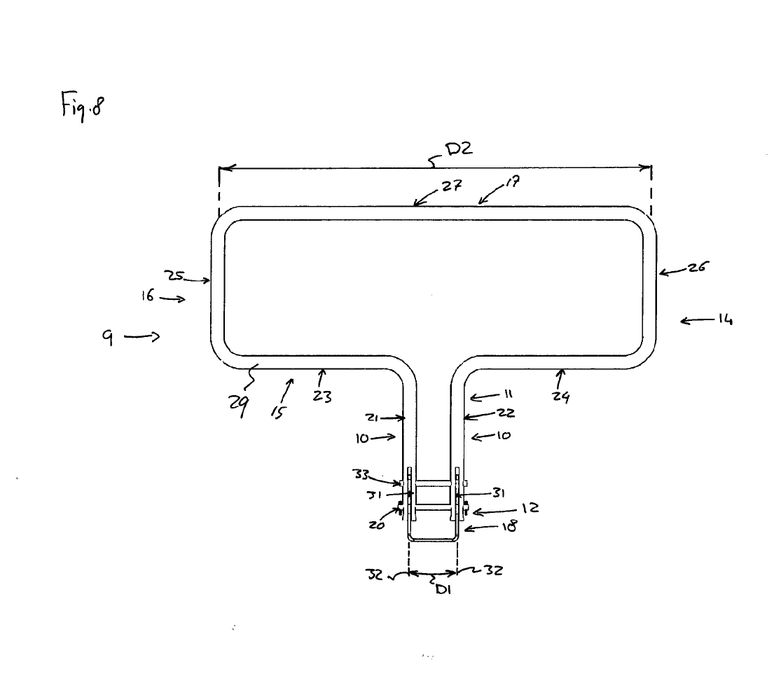

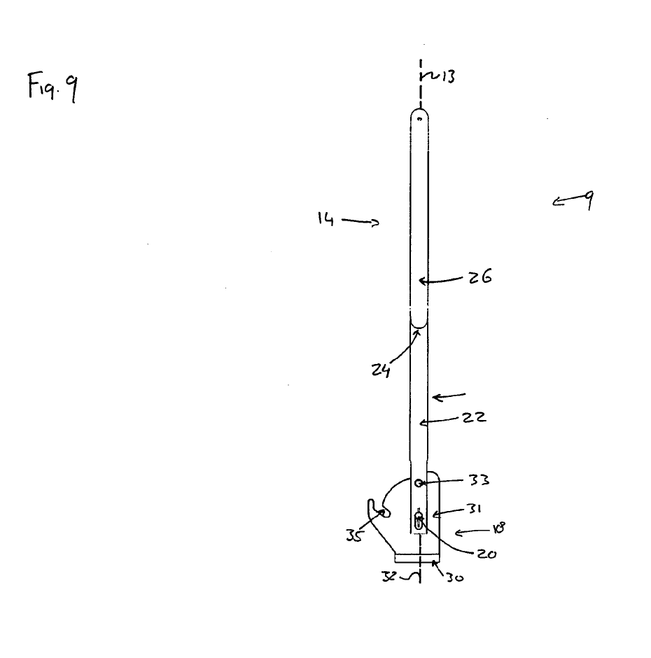

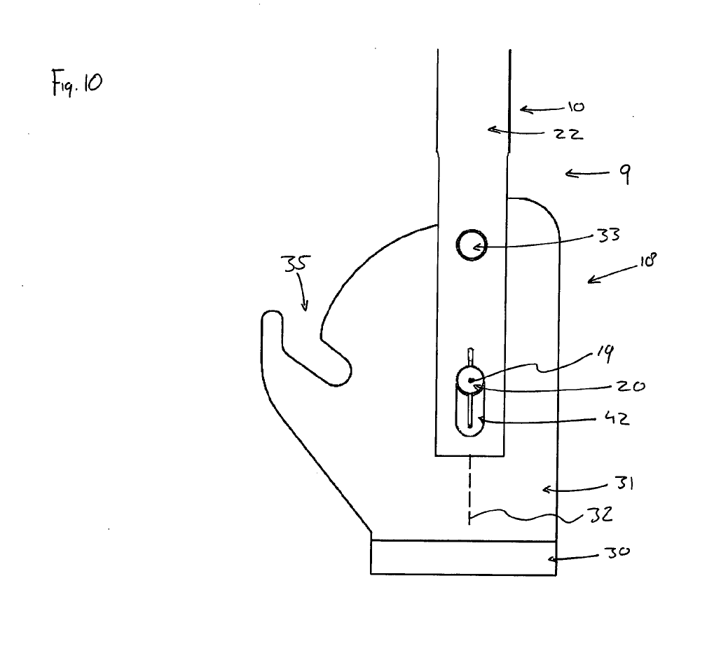

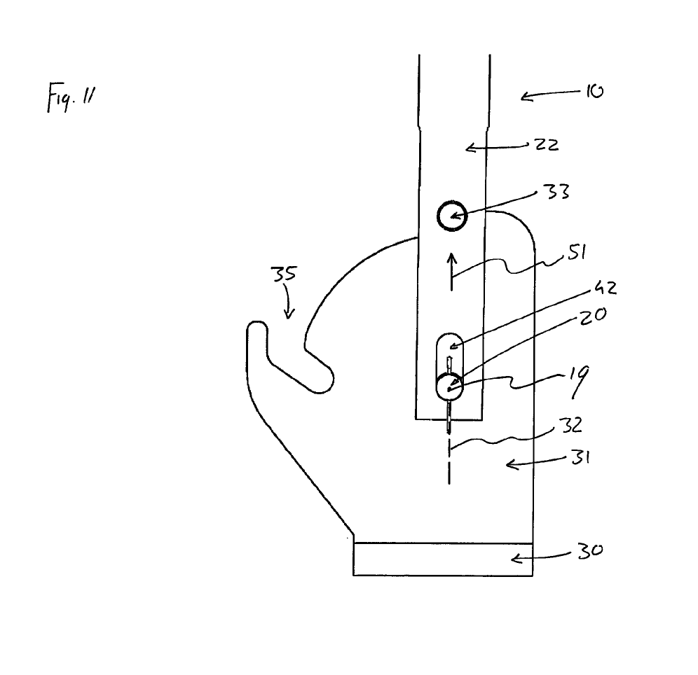

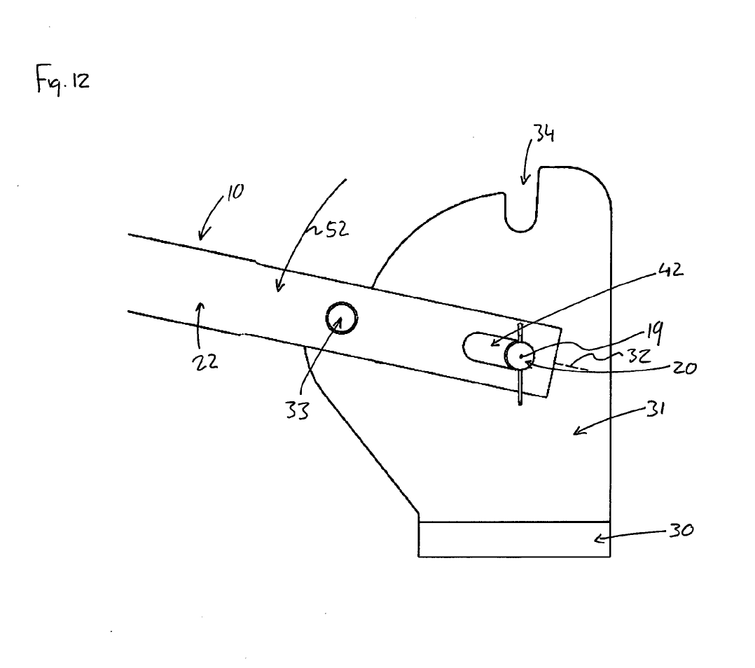

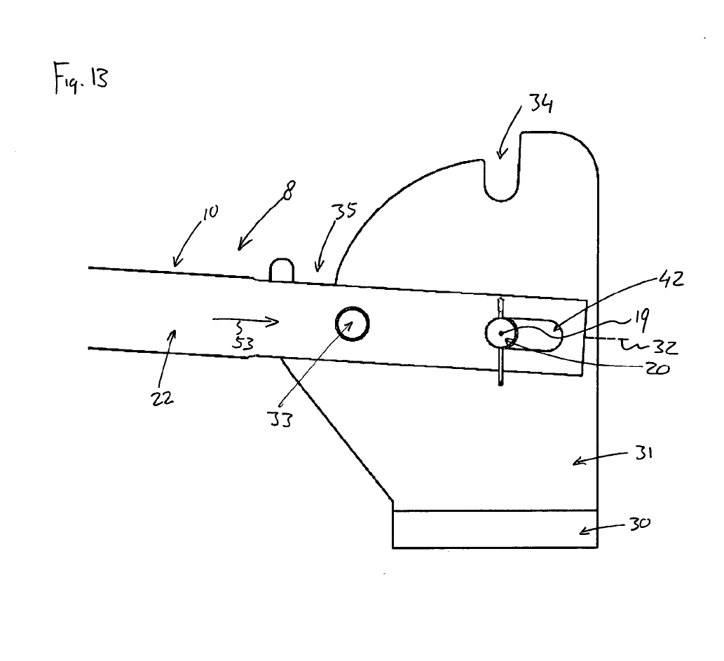

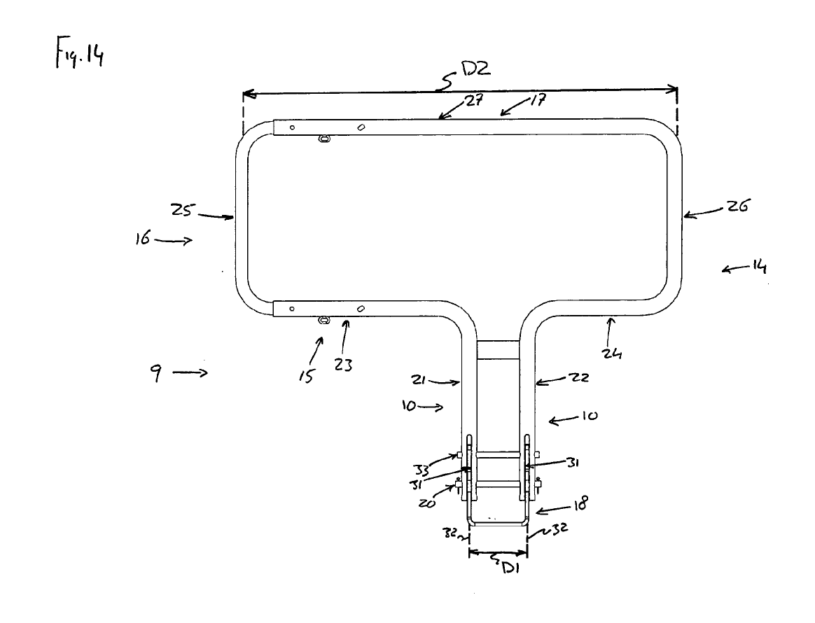

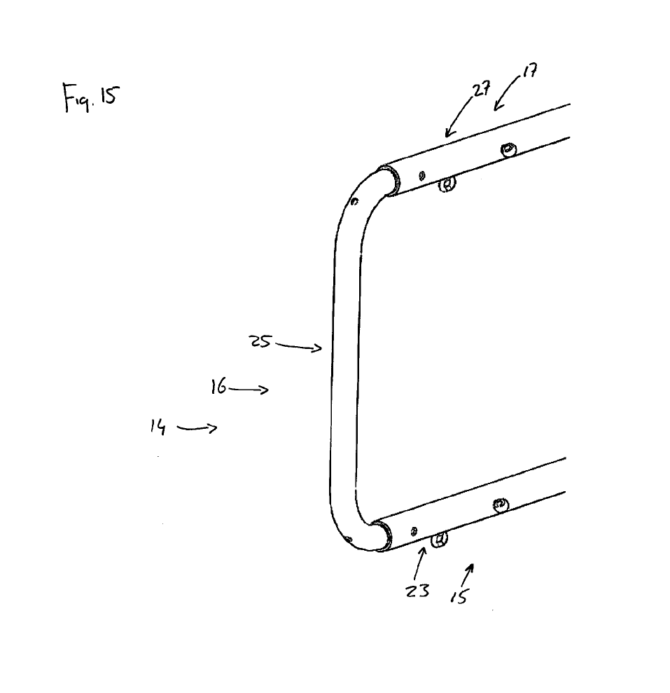

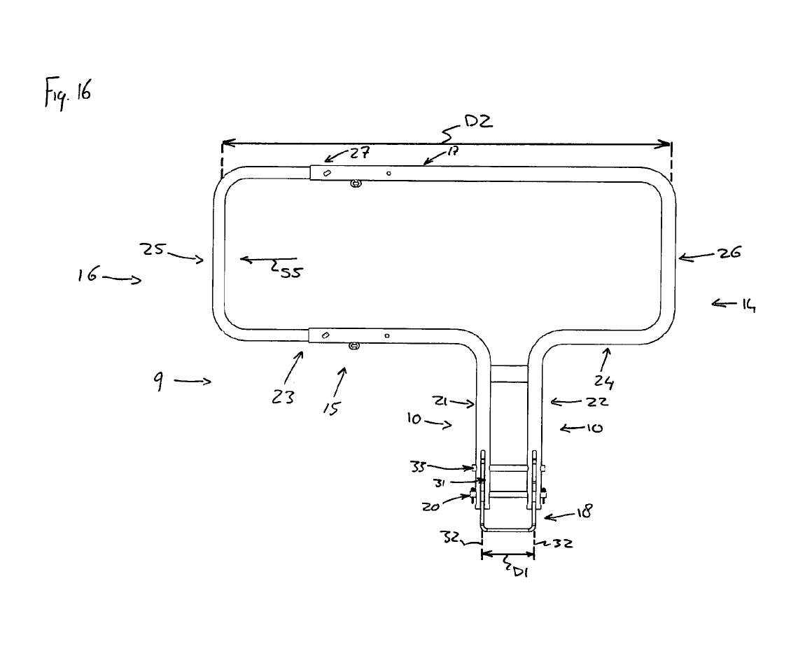

FIG. 6 shows an enlarged view in perspective of the safety rail 7 of FIG. 3 in the laid down position 8. The safety rail 7 is positioned at an angle of around 5° with the upper surface 5. In other embodiments of the mobile tank 1, the safety rail 7 extends under an angle between 0° and 10° degrees with the upper surface 5.

FIG. 7 shows an enlarged view of the support legs 10 and the connector 18 of the safety rail 7 of FIG. 6.

FIG. 8 shows a front view and FIG. 9 a side view of an alternative embodiment of the safety rail 7 for the mobile tank 1 according to the invention. The safety rail 7 only differs from the one shown in FIG. 3, in that the safety rail 7 is formed by a single tubular element 29, which is bent to form the first, second, third, fourth, fifth, sixth, and seventh tube 27.

The second distance D2 of the rail part 14 is around 10 times larger than the first distance D1 of the support legs 10. In other embodiments of the mobile tank 1, said second distance D2 is between 5-15 times larger than said first distance D1.

The first distance D1 of the support legs 10 is around 16 cm. In other examples, said first distance D1 is between 1 and 20 cm.

The FIG. 10-13 show enlarged side views of the support legs 10 and the connector 18 of the safety rail 7 of FIG. 9, which safety rail 7 is moved from the raised position 9 into the laid down position 8.

Each support leg 10 comprises a longitudinal leg axis 32 and is movable relative to the upright plate 31 to which it is connected in the direction of its longitudinal leg axis 32. Each support leg 10 further comprises a fixation member 33. Each upright plate 31 comprises an upper fixation slot 34 and a lower fixation slot 35. The upper fixation slots 34 of the two upright plates 31 are positioned to receive the fixation members 33 of the support legs 10 when the safety rail 7 is in its raised position 9 moved along the longitudinal leg axes 32 and towards the upright plates 31 in order to prevent that the safety rail 7 is pivoted out of the raised position 9. The lower fixation slots 35 of the two upright plates 31 are positioned to receive the fixation members 33 of the support legs 10 when the safety rail 7 is in its laid down position 8 moved along the longitudinal leg axes 32 and towards the upright plates 31 in order to prevent that the safety rail 7 is pivoted out of the laid down position 8.

In FIG. 10, the safety rail 7 is located in the raised position 9. The fixation members 33 of the support legs 10 are located in the upper fixation slots 34 of the upright plates 31. The fixation members 33 and the upper fixation slots 34 prevent that the safety rail can be moved out the raised position 9 by only pivoting the safety rail 7.

In FIG. 11, the safety rail 7 is moved along the longitudinal leg axes 32 and away from the upright plates 31 so that the fixation members 33 are positioned outside the upper fixation slots 34. This movement is shown by arrow 51. The safety rail 7 is movable relative to the upright plates 31, due to recesses 42 provided in the support legs 10. The recesses 42 allow that the support leg 10 can be moved in the direction of the longitudinal leg axis 32 and along the pivot axle 20 with which the support leg 10 is coupled to the connector 18.

In FIG. 12, the safety rail 7 is pivoted towards the laid down position 8, such that the fixation members 33 are located just above the lower fixation slots 35. This movement is shown by arrow 52.

In FIG. 13, the safety rail 7 pivoted further towards the laid down position 8 so that the fixation members 33 enter the lower fixation slots 35. The safety rail 7 is subsequently moved along the longitudinal leg axes 32 and towards the upright plates 31. This movement is shown by arrow 53. During this movement, the fixation members 33 are moved further into the lower fixation slots 35. The safety rail 7 is now located in the laid down position 8. The fixation members 33 and the lower fixation slots 35 prevent that the safety rail can be moved out the laid down position 8 by only pivoting the safety rail 7.

As the FIGS. 10-13 show, the upper fixation slots 34 are formed to allow that gravity working on the safety rail 7 located in the raised position 9 facilitates the movement of the fixation members 33 into the upper fixation slots 34 and the lower fixation slots 35 are formed to allow that gravity working on the safety rail 7 located in the laid down position 8 facilitates the movement of the fixation members 33 into the lower fixation slots 35.

FIG. 14 shows a front view of another alternative embodiment of the safety rail 7 for the mobile tank 1 according to the invention. The rail part 14 is extendable such that the second distance D2 over which the rail part 14 extends can be increased. The third and seventh tube 27 are extendable. In other examples, the fourth and seventh tube 27 are extendable. In yet other examples, the third, fourth and seventh tube 27 are extendable.

FIG. 15 shows an enlarged view in perspective of the extendable rail part 14 of the safety rail 7 of FIG. 14.

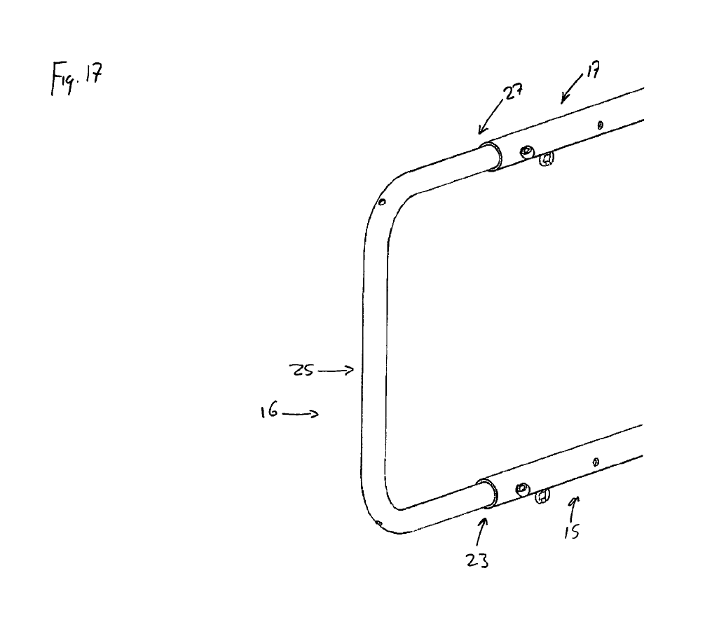

In the FIGS. 16 and 17, the third and seventh tube 27 are extended when compared with the FIGS. 14 and 15.

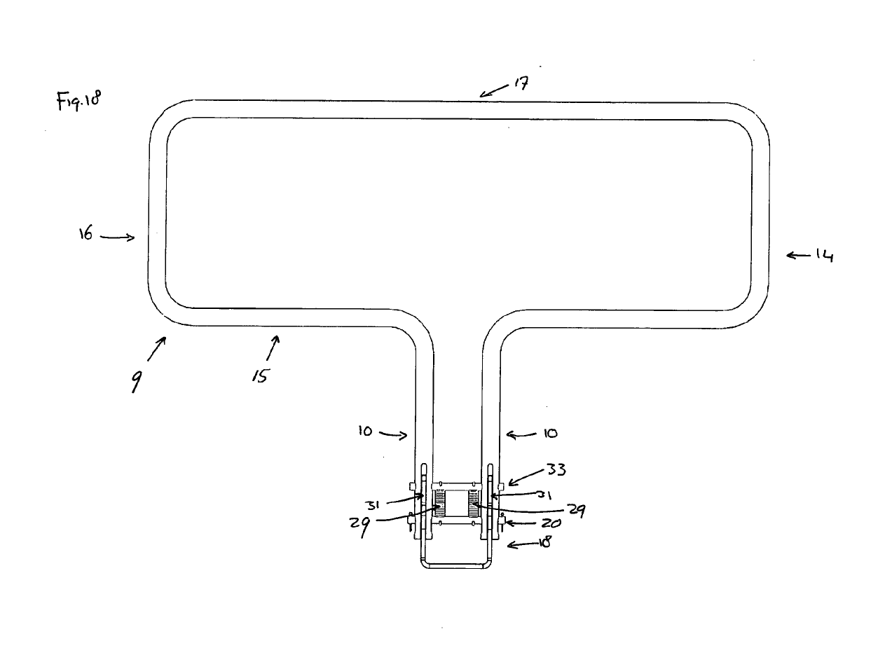

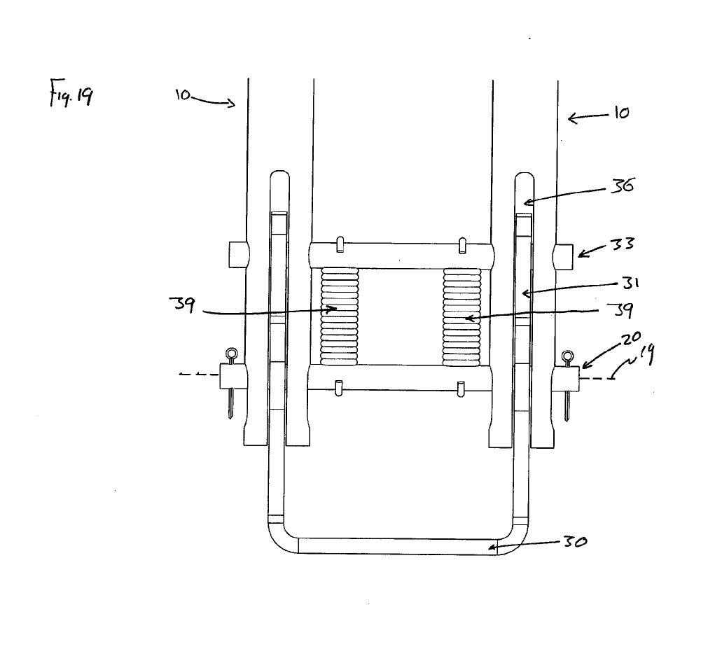

FIG. 18 shows a front view of another alternative embodiment of the safety rail 7 for the mobile tank 1 according to the invention, and FIG. 19 shows an enlarged front view of the support legs 10 and the connector 18 of the safety rail 7 of FIG. 18. The safety rail 7 only differs from the one shown in FIG. 8, in that two tension members 39 are provided. The tension members 39 are springs. In other examples, other types of tension members 39 can be used. The tension members 39 are indirectly (via the fixations members 33) attached to the support legs 10 and also to a pivot axle 20 by which the support legs 10 are coupled to the connector 18. The tension members 39 actively pull the support leg 10 towards the connector 18. This facilitates that the fixation members 33 remain in the upper fixation slots 34 or the lower fixation slots 35, when the safety rail 7 is located in the raised position 9 or the laid down position 8, respectively. In other embodiments, the safety rail 7 comprises only one tension member 39 or more than two tension members 39.

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting, but rather, to provide an understandable description of the invention.

The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language, not excluding other elements or steps). Any reference signs in the claims should not be construed as limiting the scope of the claims or the invention.

The mere fact that certain measures are recited in mutually different dependent claims does not indicate that a combination of these measures cannot be used to advantage.

It will be apparent to those skilled in the art that various modifications can be made to the device and method without departing from the scope as defined in the claims.

1.-17. (canceled)

18. A mobile tank for storing a liquid, said mobile tank comprising a bottom part, a top part and side walls extending from the bottom part to the top part to form a liquid reservoir, wherein;
a safety rail is pivotable connected to an upper surface of the top part, which safety rail is pivotable from a laid down position into a raised position, and vice versa,
the safety rail comprises two, and only two, support legs positioned at a first distance from each other and extending in a flat plane,
the safety rail further comprises a rail part connected to upper ends of the support legs, which rail part extends in the plane and in a direction transverse to the support legs over a second distance being larger than the first distance of the support legs,
the safety rail comprises one, and only one, connector by which the safety rail is connected to the upper surface, and
each of the support legs is at a lower end thereof pivotable coupled to the connector.

19. The mobile tank according to claim 18, wherein the safety rail has a T-like form.

20. The mobile tank according to claim 18, wherein the two support legs are pivotable about one, and only one, pivot axis.

21. The mobile tank according to claim 18, wherein the two support legs are coupled to the connector via one, and only one, pivot axle.

22. The mobile tank according to claim 18, wherein the second distance of the rail part is between 5-15 times larger than the first distance of the support legs.

23. The mobile tank according to claim 18, wherein the first distance of the support legs is between 1 and 20 cm.

24. The mobile tank according to claim 18, wherein;
the two support legs are formed by a first tube and a parallel extending second tube,
the rail part comprises a lower rail section, an intermediate rail section and an upper rail section,
the lower rail section is formed by a third tube connected at the upper end of the first tube and extending perpendicular to the first tube and a fourth tube connected at the upper end of the second tube and extending perpendicular to the second tube, which third and fourth tube extend in opposite directions,
the intermediate rail section is formed by a fifth tube connected to the third tube and extending perpendicular to the third tube and away from the first tube and by a sixth tube connected to the fourth tube and extending perpendicular to the fourth tube and away from the second tube,
the upper rail section is formed by a seventh tube connected to the fifth and sixth tube and extending perpendicular to the fifth and sixth tube.

25. The mobile tank according to claim 18, wherein the rail part is extendable such that the second distance over which the rail part extends can be increased.

26. The mobile tank according to claim 25 and in combination with claim 24, wherein the third and seventh tube are extendable and/or the fourth and seventh tube are extendable.

27. The mobile tank according to claim 18 and in combination with claim 24, wherein the safety rail is formed by a single tubular element which is bend to form the first, second, third, fourth, fifth, sixth, and seventh tube.

28. The mobile tank according to claim 18, wherein the safety rail extends in the laid down position under a first angle smaller than 10° relative to the upper surface and in the raised position at a second angle between 80°-100° relative to the upper surface.

29. The mobile tank according to claim 18, wherein the connector comprises a base plate which is connected to the upper surface and two upright plates and wherein each of the two support legs is pivotable coupled to a different one of the upright plates.

30. The mobile tank according to claim 29, wherein;
each support leg comprises a longitudinal leg axis and is movable relative to the upright plate to which it is connected in the direction of its longitudinal leg axis,
each support leg further comprises a fixation member,
each upright plate comprises an upper fixation slot and a lower fixation slot,
the upper fixation slots of the two upright plates are positioned to receive the fixation members of the support legs when the safety rail is in its raised position moved along the longitudinal leg axes and towards the upright plates in order to prevent that the safety rail is pivoted out of the raised position, and
the lower fixation slots of the two upright plates are positioned to receive the fixation members of the support legs when the safety rail is in its laid down position moved along the longitudinal leg axes and towards the upright plates in order to prevent that the safety rail is pivoted out of the laid down position.

31. The mobile tank according to claim 30, wherein the upper fixation slots are formed to allow that gravity working on the safety rail located in the raised position facilitates the movement of the fixation members into the upper fixation slots and the lower fixation slots are formed to allow that gravity working on the safety rail located in the laid down position facilitates the movement of the fixation members into the lower fixation slots.

32. The mobile tank according to claim 18, wherein;
the safety rail comprises at least one tension member, such as a spring,
the tension member is attached to at least one of the support legs and to a pivot axle by which said support leg is coupled to the connector, and
the tension member actively pulls the support legs towards the connector.

33. The mobile tank according to claim 18 and in combination with claim 29, wherein each of the support legs comprises at the lower end a plate recess in which one of the upright plates is positioned such that the support leg extends at opposite sides of the respective upright plate.

34. The mobile tank according to claim 18, which mobile tank comprises multiple safety rails connected to the upper surface, which safety rails are positioned to surround at least part of the upper surface.
